(19) United States
(12) Patent Application Publication
(10) Pub. No.: US 2024/0174411 A1
(43) Pub. Date: May 30, 2024

(54) BAG AND BAG FITMENT INCLUDING RIGID FLUOROPOLYMER SPIKE PORT

(71) Applicant: ENTEGRIS, INC., Billerica, MA (US)

(72) Inventors: Nicholas Coscia, Lexington, MA (US); Jacob Peabody, Roxbury, MA (US); Robert Michael Shydo, JR., Hampstead, NH (US); Paarth Thapar, Charlestown, MA (US)

(21) Appl. No.: 18/515,101

(22) Filed: Nov. 20, 2023

Related U.S. Application Data
(60) Provisional application No. 63/428,611, filed on Nov. 29, 2022.

(51) Int. Cl. B65D 47/10; B65B 51/10

(52) U.S. Cl. CPC B65D 47/10; B65B 51/10; B65D 2517/5024

(57) ABSTRACT

A fitment for a bag includes an integrally formed spike port, the spike port including an aperture, a puncture barrier film and an internal gasket. The fitment can be a fluoropolymer. The puncture barrier can be a fluoropolymer film. The internal gasket is positioned within the aperture and provides an additional puncture barrier to the spike port. The fitment can be incorporated into a bag by joining two sheets such as fluoropolymer sheets to one another and to the fitment around a perimeter of the sheets. The bag can be used in processes including exposure to or holding at cryogenic temperatures.

### FIELD

This disclosure is directed to bags including a fluoropolymer fitment including a spike port.

### BACKGROUND

Medical bags can include spike ports welded directly to sheets used to form the bag to provide fluid transfer from the bag. Cell and gene therapy bags typically use traditional medical bags and the corresponding fluid transfer methods, for example for administration in clinical settings.

### SUMMARY

This disclosure is directed to bags including a fluoropolymer fitment including a spike port.

By incorporating a spike port integrally with a fitment for a bag and joining the sheets to the fitment to form the bag, a bag can be provided that includes the spike port for fluid transfer, while also providing a bag suitable for applications that include exposure to or holding at cryogenic temperatures, for example, during processing of the contents of the bag.

In an embodiment, a fitment for a bag includes a fitment body including first and second side walls, each of the first and second side walls extending between opposing end points, the fitment body comprising a fluoropolymer material and a spike port. The spike port includes a spike port body. The spike port body is formed integrally with fitment body, and the spike port body includes an aperture configured to receive a spike. The spike port further includes a first puncture barrier comprising a fluoropolymer film and an internal gasket disposed within the spike port body. The internal gasket is configured to provide a second puncture barrier.

In an embodiment, the internal gasket comprises silicone, thermoplastic elastomer, a fluoropolymer, ethyl vinyl acetate, or a combination thereof.

In an embodiment, a diameter of the aperture is in a range from 0.18 inches (about 4.5 mm) to 0.22 inches (about 5.6 mm).

In an embodiment, the fitment further includes an addition port formed integrally with the fitment body.

In an embodiment, the first puncture barrier is joined to an end of the spike port body by a weld, the first puncture barrier covering the aperture.

In an embodiment, the first puncture barrier is disposed within the aperture.

In an embodiment, an internal surface of the spike port body includes an annular projection and an exterior surface of the internal gasket includes an annular groove.

In an embodiment, the aperture has a first diameter in a first portion of the spike port body and a second diameter, smaller than the first diameter in a second portion of the spike port body, and the internal gasket has an outer diameter that is smaller than the first diameter and larger than the second diameter.

In an embodiment, an internal surface of the spike port body includes one or more first engagement features and the internal gasket includes one or more second engagement features configured to engage with said first engagement features.

In an embodiment, a bag further includes a first fluoropolymer sheet and a second fluoropolymer sheet. A first portion of a perimeter of the first fluoropolymer sheet is welded to a first portion of a perimeter of the second fluoropolymer sheet, a second portion of the perimeter of the first fluoropolymer sheet is welded to the fitment, a second portion of the perimeter of the second fluoropolymer sheet is welded to the fitment. The first portion of the perimeter of the first fluoropolymer sheet and the second portion of the perimeter of the first fluoropolymer sheet are the entire perimeter of the first fluoropolymer sheet. The first portion of the perimeter of the second fluoropolymer sheet and the second portion of the perimeter of the second fluoropolymer sheet are the entire perimeter of the second fluoropolymer sheet.

In an embodiment, a method includes providing a fitment, the fitment including a fitment body including first and second side walls, each of the first and second side walls extending between opposing end points, the first and second side walls defining a central opening, the fitment body comprising a fluoropolymer material and a spike port body formed integrally with the fitment body, said spike port body including an aperture configured to receive a spike, the fitment comprising a fluoropolymer. The method further includes installing an internal gasket into the spike port body and welding a fluoropolymer film to the fitment to provide a puncture barrier.

In an embodiment, the method further includes providing a first fluoropolymer sheet, providing a second fluoropolymer sheet, welding a first portion of a perimeter of the first fluoropolymer sheet to a first portion of the perimeter of the second fluoropolymer sheet, and welding a second portion of the perimeter of the first fluoropolymer sheet and a second portion of the second fluoropolymer sheet to the fitment. The first portion of the perimeter of the first fluoropolymer sheet and the second portion of the perimeter of the first fluoropolymer sheet are the entire perimeter of the first fluoropolymer sheet, and the first portion of the perimeter of the second fluoropolymer sheet and the second portion of the perimeter of the second fluoropolymer sheet are the entire perimeter of the second fluoropolymer sheet.

In an embodiment, the internal gasket comprises silicone or ethyl vinyl acetate.

In an embodiment, a diameter of the aperture is in a range from 0.18 inches to 0.22 inches.

In an embodiment, the fluoropolymer film is joined to an end of the spike port body and covers the aperture.

In an embodiment, the fluoropolymer film is disposed within the spike port body.

In an embodiment, an internal surface of the spike port body includes an annular projection and an exterior surface of the internal gasket includes an annular groove and installing the internal gasket includes positioning the internal gasket such that the annular projection is received in the annular groove.

In an embodiment, the aperture has a first diameter in a first portion of the spike port body and a second diameter, smaller than the first diameter in a second portion of the spike port body. and the internal gasket has an outer diameter that is smaller than the first diameter and larger than the second diameter, and installing the internal gasket includes inserting the internal gasket into the aperture from the first portion of the spike port body.

In an embodiment, an internal surface of the spike port body includes one or more first engagement features and the internal gasket includes one or more second engagement features configured to engage with said first engagement features, and installing the internal gasket includes engaging the one or more first engagement features with the one or more second engagement features.

In an embodiment, a method of conducting a process includes providing a bag according to embodiments herein, adding a process fluid to the bag, bringing the bag to a temperature of −80° C. or lower, and inserting the spike into the aperture of the spike port.

### DRAWINGS

FIG. 1 shows a perspective view of a fitment according to an embodiment.

FIG. 2 shows a sectional view of a fitment according to an embodiment.

FIG. 3A shows a sectional view of a spike port according to an embodiment.

FIG. 3B shows a sectional view of a spike port according to an embodiment.

FIG. 3C shows a sectional view of a spike port according to an embodiment.

FIG. 3D shows a sectional view of a spike port according to an embodiment.

FIG. 4 shows a bag according to an embodiment.

FIG. 5 shows a method of manufacturing a bag according to an embodiment.

FIG. 6 shows a method of use for a bag according to an embodiment.

### DETAILED DESCRIPTION

This disclosure is directed to bags including a fluoropolymer fitment including a spike port.

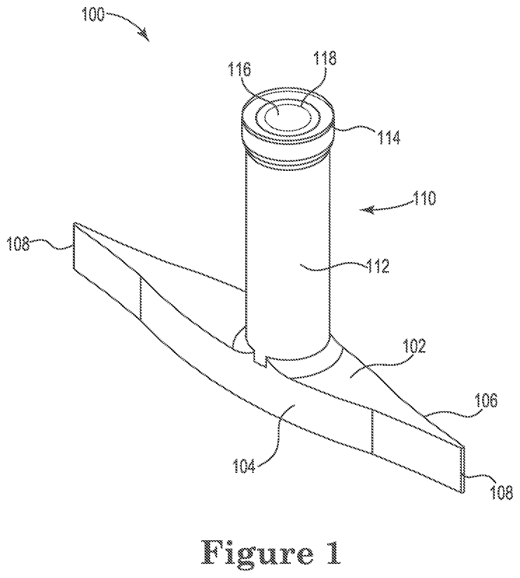

FIG. 1 shows a perspective view of a fitment according to an embodiment. Fitment 100 includes fitment body 102 having first side wall 104 and second side wall 106. Each of the first side wall 104 and second side wall 106 meet at opposing endpoints 108. A spike port 110 is formed integrally with the fitment body 102. The spike port 110 includes a spike port body 112, an end 114, an aperture 116, and a puncture barrier film 118. An internal gasket (not shown) can be included within spike port body 114.

Fitment 100 is a fitment configured to be attached to flexible sheets such as fluoropolymer sheets to form a bag including the fitment 100. The fitment 100 is configured to provide one or more ports allowing communication between an interior space of such a bag and an exterior of the bag. The fitment 100 can be a single unitary piece, with all features formed integrally, or can be assembled of multiple pieces fixed to one another, for example using one or more welds. Fitment 100 can include any suitable material, such as a fluoropolymer. In an embodiment, the entire fitment 100 is formed of the fluoropolymer. In embodiments, the fluoropolymer can include one or more of ethylenetetrafluoroethylene (ETFE) polymer, polychlorotrifluoroethylene (PCTFE) polymer, polyvinyl fluoride (PVF) polymer, polyvinylidene fluoride (PVDF) polymer, or the like. In an embodiment, the fluoropolymer is ETFE.

The fitment 100 includes first side wall 104 and second side wall 106. The first side wall 104 and second side wall 106 meet at opposing endpoints 108. One or both of first side wall 104 and second side wall 106 can be curved. In an embodiment, one or both of first side wall 104 and second side wall 104 can include one or more concave sections. In an embodiment, one or both of the first side wall 104 and second side wall 106 can include a convex section. The first side wall 104 and the second side wall 106 can provide a “boat” shape for the fitment 100. Each of first side wall 104 and second side wall 106 provide an outer surface configured to allow attachment of sheets such as fluoropolymer sheets, such that fitment 100 can be included in a bag. The first side wall 104 and the second side wall 106 can be contoured such that first side wall 104 and second side wall 106 provide attachment surfaces allowing continuous attachment of sheets or films, and smooth transitions from attachment of the sheets to one another to attachment of the sheets to the first side wall 104 or second side wall 106. In an embodiment, the first side wall 104 and the second side wall 106 can define a central opening configured to be in communication with the internal space of a bag formed by attachment of sheets or films to the fitment 100. The side walls 104, 106 can be shaped according to the disclosure of U.S. patent application Ser. No. 16/257,921, which is herein incorporated by reference in its entirety.

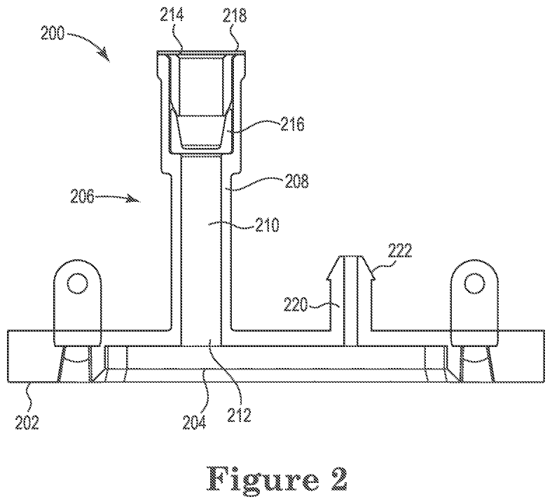

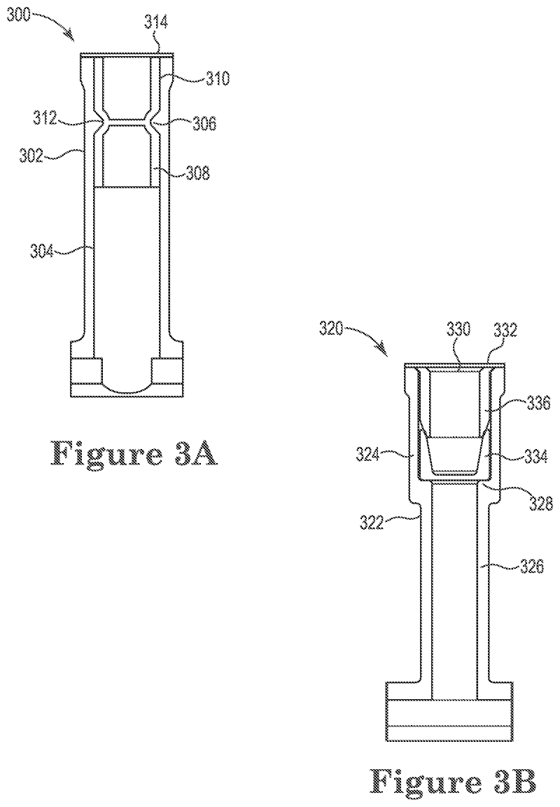

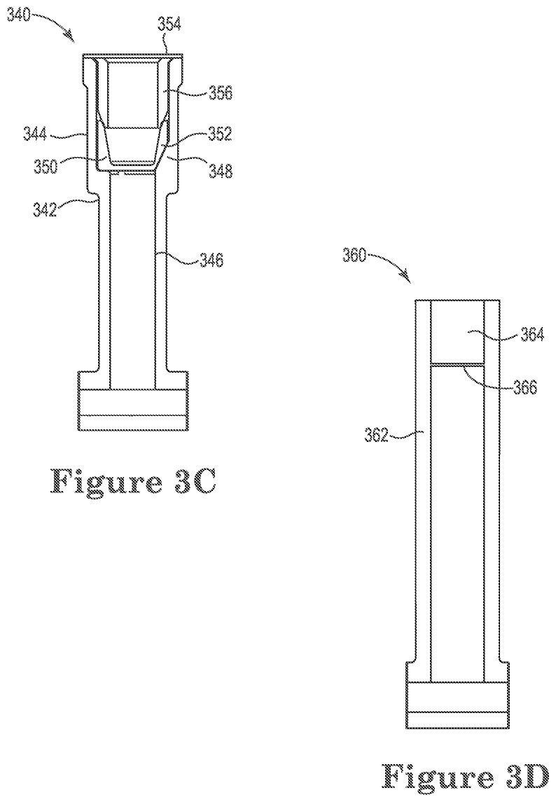

Spike port 110 is provided in the fitment 100. The spike port is configured to receive a spike such that the spike can be placed into communication with an interior space of a bag including fitment 100. Spike port 110 includes spike port body 112 extending from the fitment 100 to end 114. End 114 is positioned such that end 114 is provided outside of a bag formed using the fitment 100 when said bag is formed. The spike port body 112 can be formed integrally with other components of the fitment 100 such as first and second side walls 104, 106. The spike port body includes aperture 116, which extends through spike port body 112 from end 114 such that the aperture 116 can provide communication between and an interior space of a bag formed using fitment 100. In an embodiment, aperture 116 can connect to a central opening defined by the fitment 100, for example being defined between first and second side walls 104, 106. In an embodiment, aperture 116 passes through an entirety of the fitment 100. Aperture 116 is sized such that any suitable spike can be inserted into the spike port 110 such that fluids can be added to or removed from the bag formed using fitment 100. The aperture 116 can be sized suitable for use with one or more different types of spikes. In an embodiment, the aperture 116 is sized to be agnostic regarding manufacturer variation or sizing of spikes within defined ranges. In an embodiment, the aperture 116 has an internal diameter in a range from 0.18 inches to 0.22 inches. An internal gasket (not shown) can be provided within the spike port body 112, within aperture 116, for example as described below and shown in FIGS. 2 and 3A-3C.

Puncture barrier film 118 can be provided to close aperture 116 prior to insertion of a spike. The puncture barrier film 118 can be provided over the opening of aperture 116 at end 114 or can be provided within the aperture 116. The puncture barrier film 118 can be a polymer film of any suitable polymer. In an embodiment, the puncture barrier film 118 is a fluoropolymer film. In an embodiment, the puncture barrier film 118 is a film of the same fluoropolymer as a fluoropolymer included in the spike port body 112. In an embodiment, the puncture barrier film 118 is a film of fluoropolymer used in fluoropolymer sheets used to form the bag including fitment 100. The puncture barrier film 118 is joined to the spike port body 112 through any suitable method, for example welding, such as heat welding.

FIG. 2 shows a sectional view of a fitment according to an embodiment. Fitment 200 includes side wall 202. Side wall 202 in part defines a central opening 204. Spike port 206 joins to side wall 202. Spike port 206 includes spike port body 208, with aperture 210 formed therein. Aperture 210 includes first end 212 and second end 214. First end 212 of the aperture 210 connects to the central opening 204. The second end 214 of aperture 210 is provided at an end of the spike port body 208. An internal gasket 216 is provided within the aperture 210. A puncture barrier film 218 can be provided at or near second end 214 of the aperture 210. One or more additional ports 220 can optionally be included in the fitment 200, such as a port 220 having hose barb connection 222.

Fitment 200 is a fitment to which polymer sheets can be joined to form a bag. The fitment 200 provides an attachment area to which the polymer sheets can be joined, and provide one or more ports such as spike port 206 and optional additional ports 220 to allow communication between an interior of the bag and an exterior. Fitment 200 can be a single unitary piece, with all features formed integrally, or can be assembled of multiple pieces fixed to one another, for example using one or more welds. Fitment 200 can include any suitable material, such as a fluoropolymer. In an embodiment, the entire fitment 200 is formed of the fluoropolymer. In embodiments, the fluoropolymer can include one or more of ethylenetetrafluoroethylene (ETFE) polymer, polychlorotrifluoroethylene (PCTFE) polymer, polyvinyl fluoride (PVF) polymer, polyvinylidene fluoride (PVDF) polymer, or the like. In an embodiment, the fluoropolymer is ETFE.

In the sectional view of FIG. 2, side wall 202 is visible. Side wall 202 can be a side wall in part defining the portion of fitment 200 that polymer sheets can attach to in order to form a bag. In an embodiment, the side wall 202 is one of first side wall 104 or second side wall 106 as described above and shown in FIG. 1. In fitment 200, the side wall 202 partially defines central opening 204. Central opening 204 is provided on a side of fitment 200 facing an interior of the bag when the bag is formed by attaching polymer sheets to the fitment 200.

Spike port 206 extends from the fitment 200. The spike port 206 is a port configured to receive a spike such that fluid can be added to or removed from a bag including the fitment 200. The spike port 206 includes spike port body 208. Spike port body 208 defines the aperture 210. Aperture 210 configured to receive the spike such that the spike can be placed into communication with an interior space of a bag including fitment 200. Spike port body 208 can be formed integrally with other parts of fitment 200, such as side wall 202. Aperture 210 extends through the spike port body 208, from first end 212 to second end 214. First end 212 is positioned such that the first end 212 is provided outside of a bag formed by the joining of polymer sheets to the fitment 200. Second end 214 is configured such that it will be in communication with an internal space of a bag formed by attachment of polymer sheets to the fitment 200. In the embodiment shown in FIG. 2, second end 214 is in communication with central opening 204. In alternative embodiments, the second end can be on a side of fitment 210 opposite the first end 212. In an embodiment, the aperture 210 is sized to be agnostic regarding manufacturer variation or sizing of spikes within defined ranges. In an embodiment, the aperture 116 has an internal diameter in a range from 0.18 inches to 0.22 inches.

Internal gasket 216 is provided within aperture 210 of the spike port 206. The internal gasket is configured to provide a puncture barrier prior to insertion of a spike into aperture 210 and to retain said spike once it has been inserted into or through the internal gasket 216. The puncture barrier provided by internal gasket 216 can be in addition to a dedicated puncture barrier such as puncture barrier film 118 described above and shown in FIG. 1 or the puncture barrier film 218 provided in FIG. 2. The internal gasket 216 can be a separate piece from the spike port body 208. The internal gasket 216 can be retained within aperture 210 by any suitable connection, such as a mechanical connection, for example, a press-fit, engagement of one or more engagement features, contact with one or more shoulders formed within the spike port body 208, combinations thereof, and the like. Internal gasket 216 can be formed of any one or more suitable materials, with non-limiting examples of suitable materials including silicone, ethyl vinyl acetate (EVA) polymers, thermoplastic elastomers, fluoropolymers, neoprene, and the like. The material of internal gasket 216 can have any suitable hardness. In an embodiment, the material of internal gasket 216 has a Shore A durometer of up to 90. In an embodiment, the material of internal gasket 216 has a Shore A durometer of from 50 to 90. In an embodiment, the material of internal gasket 216 has a Shore A durometer of from 50 to 70. In an embodiment, the material of internal gasket 216 has a shore A durometer of approximately 70. The material of internal gasket 216 can have any suitable glass transition temperature selected on the conditions internal gasket 216 will be subjected to. In an embodiment, a glass transition temperature of the material of internal gasket 216 can be −30° C. or less. In an embodiment, a glass transition temperature of the material of internal gasket 216 can be −125° C. or less. In an embodiment, a glass transition temperature of the material of internal gasket 216 can be −170° C. or less.

Puncture barrier film 218 can be provided to close aperture 210 prior to insertion of a spike. The puncture barrier film 218 can be provided over the first end 212 of aperture 210 or can be provided within the aperture 210. The puncture barrier film 218 can be a polymer film of any suitable polymer. In an embodiment, the puncture barrier film 218 is a fluoropolymer film. The puncture barrier film 218 is joined to the spike port body 208 through any suitable method, for example welding, such as heat welding.

Optional port 220 can be another port provided on the fitment 200 to allow communication between an interior of a bag formed using fitment 200 and the exterior of the bag. The port 220 can be any suitable port for providing such communication. In an embodiment, port 220 can be a spike port similar or identical to spike port 208. In an embodiment, the port 220 can be a port including another connection feature, such as, for example, hose barbs 222 as shown in FIG. 2. In an embodiment, the port 220 can communicate with central opening 204. In an embodiment, the port 220 can extend through the fitment 200. In embodiments, two or more of the optional ports 220 can be included. In an embodiment, the optional additional port 220 can include a hose barb connection 222. Hose barb connection 222 can include one or more projections outwards from port 220, such as the conical projection shown in FIG. 2, such that a hose can be stretched over the hose barb connection 222 and retained in place over port 220 to facilitate transfer of fluid into or out of the bag including fitment 200 when the hose is connected. In embodiments, other suitable attachments can be provided at port 220, such as quick connection-disconnection systems, luer connection features, molded tubing, or the like. Examples of such attachments include, as non-limiting examples, aseptic connectors such as those according to U.S. Provisional Application Nos. 63/255,581 and 63/297,148, which are herein incorporated by reference in their entirety. In embodiments including more than one of the optional additional ports 222, the connectors provided at the respective ports 220 can all be the same type of connector or can be different types of connectors.

FIG. 3A shows a sectional view of a spike port according to an embodiment. Spike port 300 includes spike port body 302 having internal surface 304. Annular projection 306 extends from internal surface 304. Internal gasket 308 includes outer surface 310. An annular groove 312 is formed in the outer surface 310 of the gasket 308. In an embodiment, one or both of annular projection 306 and annular groove 312 are continuous around a circumference of internal surface 304 or outer surface 310, respectively. In an embodiment, one or both of annular projection 306 and annular groove 312 include one or more discontinuities with respect to a circumference of internal surface 304 or outer surface 310, respectively. The internal gasket 308 can be installed into spike port 300 by inserting the internal gasket 308 into the space defined by internal surface 304 to a position where the annular projection 306 is received in the annular groove 312. The internal gasket 308 can be configured such that the outer surface 310 forms a press-fit with the internal surface 304 of spike port body 302. Puncture barrier film 314 can be provided at or near the end of the spike port body 302.

FIG. 3B shows a sectional view of a spike port according to an embodiment. Spike port 320 includes spike port body 322 having a first section 324 having a first internal diameter and a second section 326 having a second internal diameter. The first internal diameter is larger than the second internal diameter. The first internal diameter and the second internal diameter can each be sized such that a spike can be received past the internal gasket 334, such that the spike can provide fluid communication through the spike port 320 including said internal gasket 334. A shoulder 328 can be provided where spike port body 322 transitions from first section 324 to second section 326. The first section 324 having the first internal diameter can be towards an end 330 where puncture barrier film 332 is provided. The second section 326 can connect to the central opening of the fitment including spike port 320, such as the central opening 110 described above and shown in FIG. 1. Internal gasket 334 can be included in spike port 320. The internal gasket 334 can be sized such that it can be inserted into the spike port body 322 at first section 324 and retained at shoulder 328. For example, internal gasket 334 can have an external diameter that is equal to or less than the first internal diameter and larger than the second internal diameter. The internal gasket 334 can be installed into spike port 320 by inserting the internal gasket 334 into the first section 324 until internal gasket 334 comes into contact with shoulder 328, thus seating the internal gasket 334. The puncture barrier film 332 can be joined to the spike port 320 at or near end 330 following insertion of the internal gasket 334 and its seating against shoulder 328. A retainer 336 can be provided to retain the internal gasket 334 in place.

FIG. 3C shows a sectional view of a spike port according to an embodiment. Spike port 340 includes spike port body 342 including first section 344 having a first internal diameter and a second section 346 having a second internal diameter. The first internal diameter and the second internal diameter can each be sized such that a spike can be received past the internal gasket 350, such that the spike can provide fluid communication through the spike port 340 including said internal gasket 350. One or more spike port body engagement features 348 can be provided on an internal surface of spike port body in one or both of first section 344, second section 346, or in a transition region between the first section 344 or second section 346. Internal gasket 350 can have an external diameter that is equal to or less than the first internal diameter and larger than the second internal diameter. Internal gasket 350 can include one or more internal gasket engagement features 352 configured to engage with the spike port body engagement features 348. The internal gasket engagement features 352 and spike port body engagement features 348 can be any suitable corresponding pair of engagement features, such as corresponding tabs, projections, detents, or the like and corresponding depressions, recesses, grooves, or the like. The internal gasket engagement features can be configured to secure the internal gasket 350 in place when the internal gasket 350 is positioned within spike port body 342. In an embodiment, the internal gasket engagement features 352 and the spike port body engagement features 348 are configured such that the engagement thereof resists rotation of the internal gasket 350 relative to spike port body 342. In an embodiment, the internal gasket engagement features 352 and the spike port body engagement features 348 are configured such that the engagement thereof resists translational motion of the internal gasket within the first section 344 of spike port body 342 such that the internal gasket does not slide within or escape from the spike port body 342. The internal gasket 350 can be installed into spike port 340 by inserting the internal gasket into the first section 344 of the spike port body and pressing the internal gasket 350 and optionally rotating the internal gasket 350 such that the internal gasket engagement features 352 and the spike port body engagement features 348 engage with one another. Puncture barrier film 354 can be provided at an end of the spike port 340. A retainer 356 can be provided to keep the internal gasket 350 in place.

FIG. 3D shows a sectional view of a spike port according to an embodiment. Spike port 360 includes spike port body 362 defining aperture 364. The internal gasket 366 is disposed within aperture 364, and formed integrally with spike port body 362. In the embodiment shown in FIG. 3D, the internal gasket 366 can be made of the same material as spike port body 362. The internal gasket 366 can completely obstruct the aperture 364 until penetrated by a spike inserted into spike port 360. The internal gasket 366 can be formed by, for example, molding the spike port body 362 to include said internal gasket 366. Optionally, where the internal gasket 366 is integrally formed with spike port body 362, the internal gasket 366 can further serve as the puncture barrier film, and a separate puncture barrier film such as puncture barrier films 314, 332, or 354 described above and shown in FIGS. 3A-3C can be optionally included or omitted.

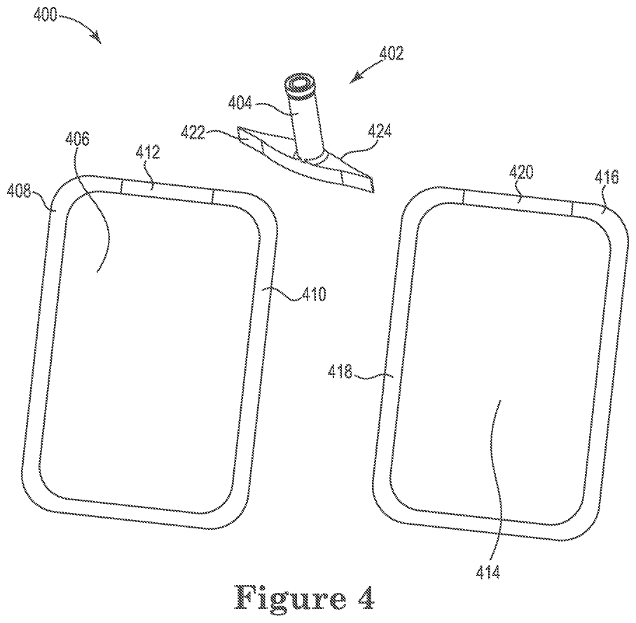

FIG. 4 shows an exploded view of a bag according to an embodiment. Bag 400 includes fitment 402 including spike port 404. Fitment 402 can be any fitment as described herein. Fitment 402 further includes first side wall 422 and second side wall 424. Fitment 402 can include or be entirely composed of a fluoropolymer material. Bag 400 further includes first sheet 406 having first perimeter 408. First sheet perimeter 408 includes first portion 410 and second portion 412. Bag 400 also includes a second sheet 414 having second sheet perimeter 416. Second perimeter 416 includes first portion 418 and second portion 420. The first sheet perimeter 408 and the second sheet perimeter 416 are outer regions of the respective first and second sheets 406, 412. One or both of first sheet 406 and second sheet 414 can include or be entirely composed of a fluoropolymer material. The fluoropolymer material used for first sheet 406 and second sheet 414 can be the same fluoropolymer material as used in fitment 402. Bag 400 can be formed by joining the first sheet perimeter 408 to the second sheet perimeter 416 at the respective first portions 410. 418. Forming the bag 400 further includes joining the second portion 412 of the first sheet perimeter 408 to the first side wall 422 of fitment 402, and joining the second portion 420 of the second perimeter 416 to the second side wall 424 of fitment 402. The entire first sheet perimeter 408 and the entire second sheet perimeter 416 are joined to either the other sheet perimeter 408, 416 or the fitment 402 to separate the interior of the bag from an external environment. The joining of the first sheet perimeter 408 and the second sheet perimeter 416 and/or the fitment 402 can be any suitable means of joining the materials, such as welds, for example heat welds. In an embodiment, the weld can have a weld width in a range from about ⅛ inch (about 3.2 millimeters (mm)) to about ½ inch (about 12.7 mm). The use of a larger weld width may provide robustness to the weld during cooling and warming of the bag. The joining of the perimeters 408, 416 can be at a position spaced apart from the edges of the first and second sheets 406, 414 but still within the outer regions thereof, as suitable for the formation of the bag. In an embodiment, the welds joining first sheet 406 and second sheet 414 can have the same weld width as the weld joining first sheet 406 to fitment 402 and/or the weld joining second sheet 414 to fitment 402. In an embodiment, the welds joining first sheet 406 and second sheet 414 can have a weld thickness different from that of the weld joining first sheet 406 to fitment 402 and/or the weld joining second sheet 414 to fitment 402.

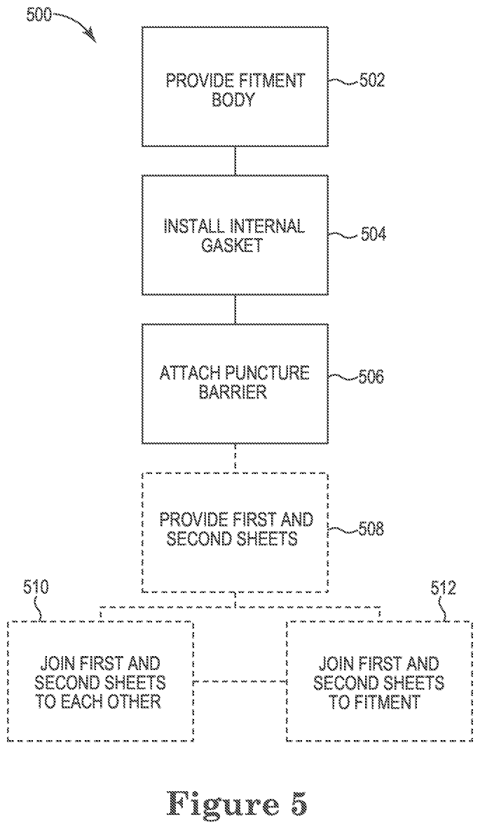

FIG. 5 shows a method of manufacturing a bag according to an embodiment. Method 500 includes providing the fitment body 502, installing an internal gasket into the fitment body 504, and attaching the puncture barrier 506. Method 500 can further include providing the first and second sheets 508, joining the first sheet to the second sheet 510, and joining the first sheet and the second sheet to the fitment 512.

A fitment body is provided at 502. The fitment body includes a spike port. In an embodiment, the spike port can be attached to the fitment body by a weld. In an embodiment, the spike port can be integrally formed with the fitment body. The fitment body can be any fitment body including a spike port as described herein, for example fitment 100 shown in FIG. 1 and described above, fitment 200 as shown in FIG. 2 and described above, fitments including one of spike ports 300, 320, 340 as shown in FIGS. 3A-3C and described above, and the like. The fitment body provided at 502 can be formed of a fluoropolymer material.

An internal gasket is installed into the fitment body at 504. The internal gasket can be configured such that it can be installed into the fitment body, for example by having an outer diameter equal to or less than an inner diameter of at least a portion of the spike port included in the fitment body. In an embodiment, installation of the internal gasket at 504 includes insertion of the internal gasket into the spike port. The internal gasket can be inserted to a position where it forms a press-fit against the inner surface of the spike port. The internal gasket can be inserted to a depth where it contacts a shoulder formed where the inner diameter of the spike port changes from a first inner diameter to the second inner diameter. The internal gasket can be inserted such that corresponding engagement features provided on the internal gasket and on the inner surface of the spike port can be engaged with one another, for example to retain the internal gasket and/or prevent rotation thereof relative to the spike port.

A puncture barrier is attached at 506. The puncture barrier can be, for example, a fluoropolymer film. The puncture barrier can be attached at 506 such that it closes off an aperture provided in the spike port. The puncture barrier can be attached at an end of the spike port, within the aperture, or in any other suitable location where it can close off the aperture through the spike port of the fitment. In an embodiment, the puncture barrier is attached at the end of the spike port. The puncture barrier can be attached through any suitable means of attachment resulting in a seal. In an embodiment, the puncture barrier is attached by way of a weld such as a heat weld, and ultrasonic weld, or any other suitable weld. In an embodiment, the puncture barrier is attached by way of a heat weld.

First and second sheets can be provided 508 to form a bag including the fitment having the spike port, internal gasket, and puncture barrier. The first and second sheets can be sheets of any suitable material, such as, for example, a film of a fluoropolymer material. In an embodiment, the first and second sheets can include a fluoropolymer material that is also included in the fitment body. In an embodiment, the first and second sheets include ethylenetetrafluoroethylene (ETFE). The first and second sheets can be sized and shaped suitably to form the bag.

The first and second sheets can be joined to one another at 510. The first and second sheets are joined over portions of the perimeters thereof, at or near the outermost edges thereof. The sheets can be joined by, for example, a weld such as a heat weld. The weld can be continuous over the portions of the perimeters of the first and second sheets. In an embodiment, the weld can have a weld width in a range from about ⅛ inch (about 3.2 millimeters (mm)) to about ½ inch (about 12.7 mm).

The first sheet and the second sheet can be joined to the fitment at 512. A portion of the perimeter of the first sheet that is not or will not be joined to the second sheet is attached to the first side wall of the fitment. A portion of the perimeter of the second sheet that is not or will not be joined to the first sheet is attached to the second side wall of the fitment. The attachment of the first sheet and the second sheet to the fitment can be through any suitable method of joining the sheets and the fitment. In an embodiment, the first and second sheets are joined to the fitment at 512 by way of welds, such as, for example, a heat weld. In an embodiment, the weld can have a weld width in a range from about ⅛ inch (about 3.2 millimeters (mm)) to about ½ inch (about 12.7 mm). The attachment of the first sheet and the second sheet to the fitment can be through continuous attachments that meet the joining of the first sheet and the second sheet to one another. The continuous attachment can reduce or eliminate weak points in the attachment of the sheets and the fitment to one another. While method 500 is shown in FIG. 5 as having the first and second sheets be joined to one another at 510 before being connected to the fitment at 512, it is understood that the order of these steps can be varied. In an embodiment, the first sheet and/or the second sheet can be joined to the fitment at 512 prior to the first and second sheets being joined to one another at 510. In an embodiment, the first and second sheets can be joined to one another at 510 at a period of time overlapping the time when the first and second sheets are joined to the fitment at 512. When the sheets are attached to one another at 510 and to the fitment at 512, only the fitment can allow communication with an internal space of the resulting bag, for example by way of the spike port.

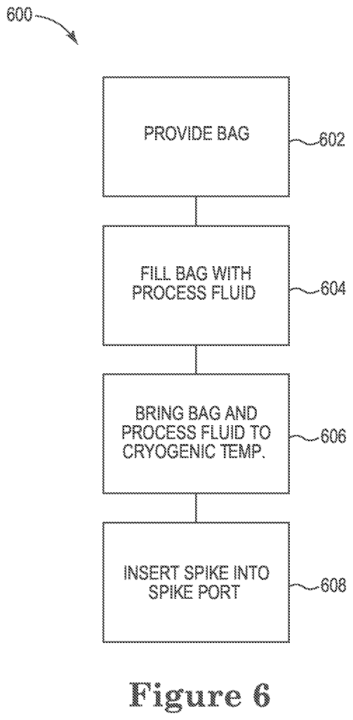

FIG. 6 shows a method of use for a bag according to an embodiment. Method 600 includes providing the bag 602, filling the bag with a process fluid 604, bringing the bag and process fluid to a cryogenic temperature 606, and inserting the spike into the spike port 608. The bag provided at 602 can be any bag provided herein, including a fitment including a spike port. The bag can be filled with process fluid at 604. The process fluid can be any suitable process fluid, such as a bioreaction mixture, for example including cells, cell media, gene therapy materials, and/or any other suitable contents for a process fluid. The bag and process fluid can be exposed to or brought to cryogenic temperatures at 606, for example bringing the bag and process fluid to dry ice temperatures, liquid nitrogen temperatures, or the like. In an embodiment, the bag can be brought to cryogenic temperatures in a freezing system (e.g., a blast chiller, low temperature freezer, or the like). In an embodiment, the bag is exposed to a temperature of −50° C. or lower. In an embodiment, the bag is exposed to a temperature of −80° C. or lower. In an embodiment, the bag is exposed to a temperature of −150° C. or lower. In an embodiment, the bag is exposed to a temperature of −190° C. or lower. Subsequent to the cryogenic exposure at 606, a spike can be inserted into the bag 608. The spike is inserted through the spike port included in the fitment of the bag provided at 602. In an embodiment, the bag and process fluid can be thawed following the cryogenic exposure at 606 and prior to the insertion of the spike at 608. The insertion of the spike can be used when extracting the process fluid from the bag, for example to transfer the process fluid to another vessel, administer the process fluid to a subject, or any other suitable extraction of process fluid from the bag.

### Aspects

It is understood that any of aspects 1-10 and 21 can be combined with any of aspects 11-19 or aspect 20. It is understood that any of aspects 11-19 can be combined with aspect 20.

Aspect 1. A fitment for a bag, comprising:
a fitment body including first and second side walls, each of the first and second side walls extending between opposing end points, the fitment body comprising a fluoropolymer material; and
a spike port, comprising:
   a spike port body, said spike port body formed integrally with fitment body, said spike port body including an aperture configured to receive a spike;
   a first puncture barrier comprising a fluoropolymer film; and
   an internal gasket disposed within the spike port body, said internal gasket configured to provide a second puncture barrier.

Aspect 2. The fitment of claim 1, wherein the internal gasket comprises silicone, thermoplastic elastomer, a fluoropolymer, ethyl vinyl acetate, or a combination thereof.

Aspect 3. The fitment according to any of aspects 1-2, wherein a diameter of the aperture is in a range from 0.18 inches (about 4.5 mm) to 0.22 inches (about 5.6 mm).

Aspect 4. The fitment according to any of aspects 1-3, further comprising an additional port formed integrally with the fitment body.

Aspect 5. The fitment according to any of aspects 1-4, wherein the first puncture barrier is joined to an end of the spike port body by a weld, the first puncture barrier covering the aperture.

Aspect 6. The fitment according to any of aspects 1-5, wherein the first puncture barrier is disposed within the aperture.

Aspect 7. The fitment according to any of aspects 1-6, wherein an internal surface of the spike port body includes an annular projection and an exterior surface of the internal gasket includes an annular groove.

Aspect 8. The fitment according to any of aspects 1-7, wherein the aperture has a first diameter in a first portion of the spike port body and a second diameter, smaller than the first diameter in a second portion of the spike port body, and the internal gasket has an outer diameter that is smaller than the first diameter and larger than the second diameter.

Aspect 9. The fitment according to aspect 8, wherein an internal surface of the spike port body includes one or more first engagement features and the internal gasket includes one or more second engagement features configured to engage with said first engagement features.

Aspect 10. A bag, comprising the fitment according to any of claims 1-9, a first fluoropolymer sheet, and a second fluoropolymer sheet,
wherein a first portion of a perimeter of the first fluoropolymer sheet is welded to a first portion of a perimeter of the second fluoropolymer sheet,
a second portion of the perimeter of the first fluoropolymer sheet is welded to the fitment,
a second portion of the perimeter of the second fluoropolymer sheet is welded to the fitment,
   the first portion of the perimeter of the first fluoropolymer sheet and the second portion of the perimeter of the first fluoropolymer sheet are the entire perimeter of the first fluoropolymer sheet, and
   the first portion of the perimeter of the second fluoropolymer sheet and the second portion of the perimeter of the second fluoropolymer sheet are the entire perimeter of the second fluoropolymer sheet.

Aspect 11. A method, comprising:
providing a fitment, the fitment including a fitment body including first and second side walls, each of the first and second side walls extending between opposing end points, the first and second side walls defining a central opening, the fitment body comprising a fluoropolymer material and a spike port body formed integrally with the fitment body, said spike port body including an aperture configured to receive a spike, the fitment comprising a fluoropolymer;
installing an internal gasket into the spike port body; and
welding a fluoropolymer film to the fitment to provide a puncture barrier.

Aspect 12. The method of claim 11, further comprising:
providing a first fluoropolymer sheet;
providing a second fluoropolymer sheet;
welding a first portion of a perimeter of the first fluoropolymer sheet to a first portion of the perimeter of the second fluoropolymer sheet; and
welding a second portion of the perimeter of the first fluoropolymer sheet and a second portion of the second fluoropolymer sheet to the fitment,
wherein the first portion of the perimeter of the first fluoropolymer sheet and the second portion of the perimeter of the first fluoropolymer sheet are the entire perimeter of the first fluoropolymer sheet, and
   the first portion of the perimeter of the second fluoropolymer sheet and the second portion of the perimeter of the second fluoropolymer sheet are the entire perimeter of the second fluoropolymer sheet.

Aspect 13. The method according to any of aspects 11-12, wherein the internal gasket comprises silicone, thermoplastic elastomer, a fluoropolymer, ethyl vinyl acetate, or a combination thereof.

Aspect 14. The method according to any of aspects 11-13, wherein a diameter of the aperture is in a range from 0.18 inches (about 4.5 mm) to 0.22 inches (about 5.6 mm).

Aspect 15. The method according to any of aspects 11-14, wherein the fluoropolymer film is joined to an end of the spike port body and covers the aperture.

Aspect 16. The method according to any of aspects 11-15, wherein the fluoropolymer film is disposed within the spike port body.

Aspect 17. The method according to any of aspects 11-16, wherein an internal surface of the spike port body includes an annular projection and an exterior surface of the internal gasket includes an annular groove and installing the internal gasket includes positioning the internal gasket such that the annular projection is received in the annular groove.

Aspect 18. The method according to any of aspects 11-17, wherein the aperture has a first diameter in a first portion of the spike port body and a second diameter, smaller than the first diameter in a second portion of the spike port body, and the internal gasket has an outer diameter that is smaller than the first diameter and larger than the second diameter, and installing the internal gasket includes inserting the internal gasket into the aperture from the first portion of the spike port body.

Aspect 19. The method according to aspect 18, wherein an internal surface of the spike port body includes one or more first engagement features and the internal gasket includes one or more second engagement features configured to engage with said first engagement features, and installing the internal gasket includes engaging the one or more first engagement features with the one or more second engagement features.

Aspect 20. A method of conducting a process, comprising:
providing a bag according to aspect 10;
adding a process fluid to the bag;
bringing the bag to a temperature of −80° C. or lower; and
inserting the spike into the aperture of the spike port.

Aspect 21. The fitment according to any of aspects 1-9, wherein the spike port is agnostic to configuration of the spike.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A fitment for a bag, comprising:
a fitment body including first and second side walls, each of the first and second side walls extending between opposing end points, the fitment body comprising a fluoropolymer material; and
a spike port, comprising:
a spike port body, said spike port body formed integrally with fitment body, said spike port body including an aperture configured to receive a spike;
a first puncture barrier comprising a fluoropolymer film; and
an internal gasket disposed within the spike port body, said internal gasket configured to provide a second puncture barrier.

2. The fitment of claim 1, wherein the internal gasket comprises silicone, thermoplastic elastomer, a fluoropolymer, ethyl vinyl acetate, or a combination thereof.

3. The fitment of claim 1, wherein a diameter of the aperture is in a range from 0.18 inches to 0.22 inches.

4. The fitment of claim 1, further comprising an additional port formed integrally with the fitment body.

5. The fitment of claim 1, wherein the first puncture barrier is joined to an end of the spike port body by a weld, the first puncture barrier covering the aperture.

6. The fitment of claim 1, wherein the first puncture barrier is disposed within the aperture.

7. The fitment of claim 1, wherein an internal surface of the spike port body includes an annular projection and an exterior surface of the internal gasket includes an annular groove.

8. The fitment of claim 1, wherein the aperture has a first diameter in a first portion of the spike port body and a second diameter, smaller than the first diameter in a second portion of the spike port body, and the internal gasket has an outer diameter that is smaller than the first diameter and larger than the second diameter.

9. The fitment of claim 8, wherein an internal surface of the spike port body includes one or more first engagement features and the internal gasket includes one or more second engagement features configured to engage with said first engagement features.

10. A bag, comprising the fitment of claim 1, a first fluoropolymer sheet, and a second fluoropolymer sheet,
wherein a first portion of a perimeter of the first fluoropolymer sheet is welded to a first portion of a perimeter of the second fluoropolymer sheet,
a second portion of the perimeter of the first fluoropolymer sheet is welded to the fitment,
a second portion of the perimeter of the second fluoropolymer sheet is welded to the fitment,
the first portion of the perimeter of the first fluoropolymer sheet and the second portion of the perimeter of the first fluoropolymer sheet are the entire perimeter of the first fluoropolymer sheet, and
the first portion of the perimeter of the second fluoropolymer sheet and the second portion of the perimeter of the second fluoropolymer sheet are the entire perimeter of the second fluoropolymer sheet.

11. A method, comprising:
providing a fitment, the fitment including a fitment body including first and second side walls, each of the first and second side walls extending between opposing end points, the first and second side walls defining a central opening, the fitment body comprising a fluoropolymer material and a spike port body formed integrally with the fitment body, said spike port body including an aperture configured to receive a spike, the fitment comprising a fluoropolymer;
installing an internal gasket into the spike port body; and
welding a fluoropolymer film to the fitment to provide a puncture barrier.

12. The method of claim 11, further comprising:
providing a first fluoropolymer sheet;
providing a second fluoropolymer sheet;
welding a first portion of a perimeter of the first fluoropolymer sheet to a first portion of the perimeter of the second fluoropolymer sheet; and
welding a second portion of the perimeter of the first fluoropolymer sheet and a second portion of the second fluoropolymer sheet to the fitment,
wherein the first portion of the perimeter of the first fluoropolymer sheet and the second portion of the perimeter of the first fluoropolymer sheet are the entire perimeter of the first fluoropolymer sheet, and
the first portion of the perimeter of the second fluoropolymer sheet and the second portion of the perimeter of the second fluoropolymer sheet are the entire perimeter of the second fluoropolymer sheet.

13. The method of claim 11, wherein the internal gasket comprises silicone, thermoplastic elastomer, a fluoropolymer, ethyl vinyl acetate, or a combination thereof.

14. The method of claim 11, wherein a diameter of the aperture is in a range from 0.18 inches to 0.22 inches.

15. The method of claim 11, wherein the fluoropolymer film is joined to an end of the spike port body and covers the aperture.

16. The method of claim 11, wherein the fluoropolymer film is disposed within the spike port body.

17. The method of claim 11, wherein an internal surface of the spike port body includes an annular projection and an exterior surface of the internal gasket includes an annular groove and installing the internal gasket includes positioning the internal gasket such that the annular projection is received in the annular groove.

18. The method of claim 11, wherein the aperture has a first diameter in a first portion of the spike port body and a second diameter, smaller than the first diameter in a second portion of the spike port body, and the internal gasket has an outer diameter that is smaller than the first diameter and larger than the second diameter, and installing the internal gasket includes inserting the internal gasket into the aperture from the first portion of the spike port body.

19. The method of claim 18, wherein an internal surface of the spike port body includes one or more first engagement features and the internal gasket includes one or more second engagement features configured to engage with said first engagement features, and installing the internal gasket includes engaging the one or more first engagement features with the one or more second engagement features.

20. A method of conducting a process, comprising:
providing a bag according to claim 10;
adding a process fluid to the bag;
bringing the bag to a temperature of −80° C. or lower; and
inserting the spike into the aperture of the spike port.
